(19) United States
(12) Patent Application Publication
(10) Pub. No.: US 2012/0315792 A1
(43) Pub. Date: Dec. 13, 2012

(54) MAGNETIC DEVICE

(75) Inventor: Brian Patrick Costello, Scotts Valley, CA (US)

(73) Assignee: TYCO ELECTRONICS CORPORATION, Berwyn, PA (US)

(21) Appl. No.: 13/155,081

(22) Filed: Jun. 7, 2011

(51) Int. Cl. H01R 13/66; H01F 17/04

(52) U.S. Cl. 439/620.01; 336/221

(57) ABSTRACT

A magnetic device includes a molded dielectric housing having an upper shell and a lower shell that are coupled together to define an interior compartment therebetween. The upper and lower shells include interior sides that oppose each other and include interior surfaces. A magnetic core is disposed within the interior compartment of the housing. Upper electrical traces formed on the interior surface of the upper shell. Lower electrical traces formed on the interior surface of the lower shell. Corresponding upper and lower electrical traces are electrically connected together to form an electrically conductive pattern of wrappings around the magnetic core that is configured to induce a magnetic field about the magnetic core.

### BACKGROUND OF THE INVENTION

The subject matter herein relates generally to magnetic devices.

Magnetic devices are used to provide a wide variety of functions, whether as stand-alone components or within larger devices and/or systems. For example, magnetic devices may be used as transformers, inductors, filters, chokes, components of relays, and/or the like. One example of the use of a magnetic device within a larger electronic device includes embedding a magnetic device within an electrical connector. The magnetic device functions as a transformer that filters data signals communicated through the connector.

Magnetic devices include a core that has permeability properties, such as a ferromagnetic material having a toroid, rod, or other shape. Typically, one or more wires are wound around the core. When electrical current is applied to the wire(s), a magnetic field is induced about the core to provide the desired functionality of the magnetic device. However, because of the variable nature of winding the wire(s) around the core, magnetic devices may suffer from relatively considerable part-to-part performance variation. In other words, the electrical performance (e.g., capacitance, longitudinal balance, leakage inductance, etc.) of the magnetic device may vary considerably because of the difficulty in maintaining control over the placement of the wire(s) around the core. Such a part-to-part performance variation may be especially considerable when the wire(s) is manually wound around the core by a person. Moreover, manually winding one or more wire(s) around a magnetic core may be time-consuming, which may increase the cost of fabricating a magnetic device and/or may limit the number of devices that can be fabricated in a given amount of time.

There is a need for a magnetic device which can be easily manufactured with low variation in electrical performance between multiple such devices.

### BRIEF DESCRIPTION OF THE INVENTION

In one embodiment, a magnetic device includes a molded dielectric housing having an upper shell and a lower shell that are coupled together to define an interior compartment therebetween. The upper and lower shells include interior sides that oppose each other and include interior surfaces. A magnetic core is disposed within the interior compartment of the housing. Upper electrical traces formed on the interior surface of the upper shell. Lower electrical traces formed on the interior surface of the lower shell. Corresponding upper and lower electrical traces are electrically connected together to form an electrically conductive pattern of wrappings around the magnetic core that is configured to induce a magnetic field about the magnetic core.

In another embodiment, a magnetic device includes a dielectric housing having an upper shell and a lower shell that are coupled together to define an interior compartment therebetween. The upper and lower shells include interior sides. A magnetic core is disposed within the interior compartment of the housing. Upper electrical traces are formed on the upper shell. Lower electrical traces are formed on the lower shell. The magnetic device also includes an electrically conductive epoxy bonded with the interior sides of the upper and lower shells to hold the upper and lower shells together. The electrically conductive epoxy is bonded and electrically connected to the upper and lower electrical traces such that the electrically conductive epoxy electrically connects corresponding upper and lower electrical traces together. Corresponding upper and lower electrical traces form an electrically conductive pattern of wrappings around the magnetic core that is configured to induce a magnetic field about the magnetic core.

In another embodiment, an electrical connector includes a connector housing, an electrical contact held by the connector housing, and a magnetic device electrically connected to the electrical contact of the housing. The magnetic device includes a molded dielectric housing having an upper shell and a lower shell that are coupled together to define an interior compartment therebetween. The upper and lower shells include interior sides that oppose each other and include interior surfaces. A magnetic core is disposed within the interior compartment of the housing. Upper electrical traces are formed on the interior surface of the upper shell. Lower electrical traces are formed on the interior surface of the lower shell. Corresponding upper and lower electrical traces are electrically connected together to form an electrically conductive pattern of wrappings around the magnetic core that is configured to induce a magnetic field about the magnetic core.

### BRIEF DESCRIPTION OF THE DRAWINGS

FIG. 1 is a perspective view of an exemplary embodiment of a magnetic device.

FIG. 2 is a cross-sectional view of the magnetic device of FIG. 1 taken along line 2-2 of FIG. 1.

FIG. 3 is an exploded perspective view of the magnetic device of FIG. 1.

FIG. 4 is another exploded perspective view of the magnetic device of FIG. 1 viewed from a different angle than FIG. 3.

FIG. 5 is an exploded perspective view of another exemplary embodiment of a magnetic device.

FIG. 6 is another exploded perspective view of the magnetic device of FIG. 5 viewed from a different angle than FIG. 5.

FIG. 7 is a partially exploded perspective view of a portion of an exemplary embodiment of an electrical connector that includes the magnetic device of FIG. 1.

### DETAILED DESCRIPTION OF THE INVENTION

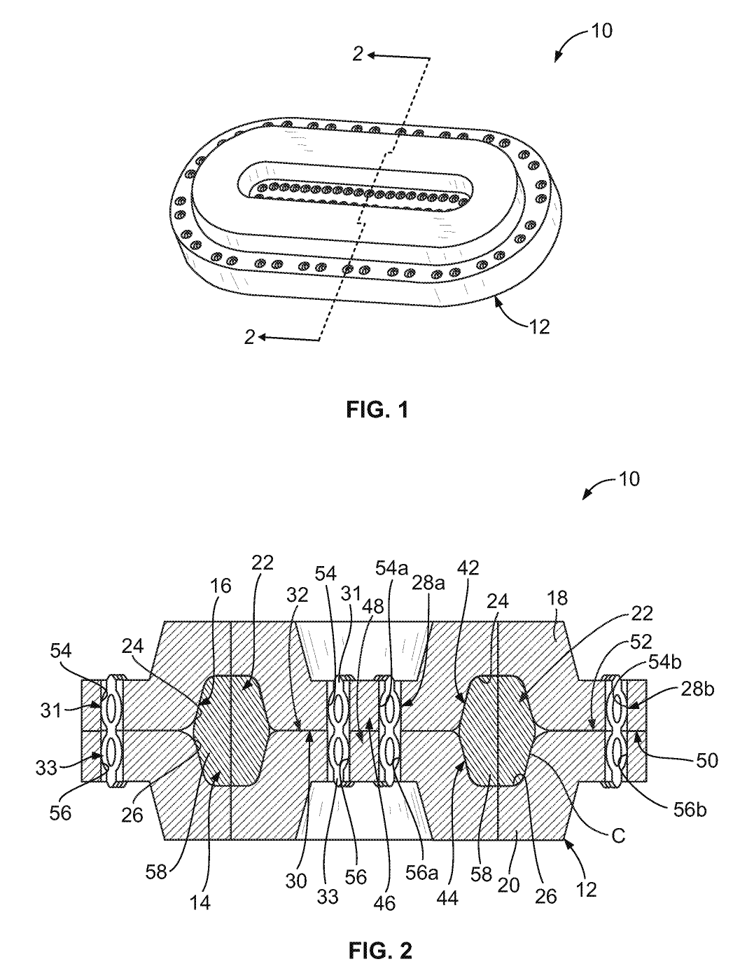

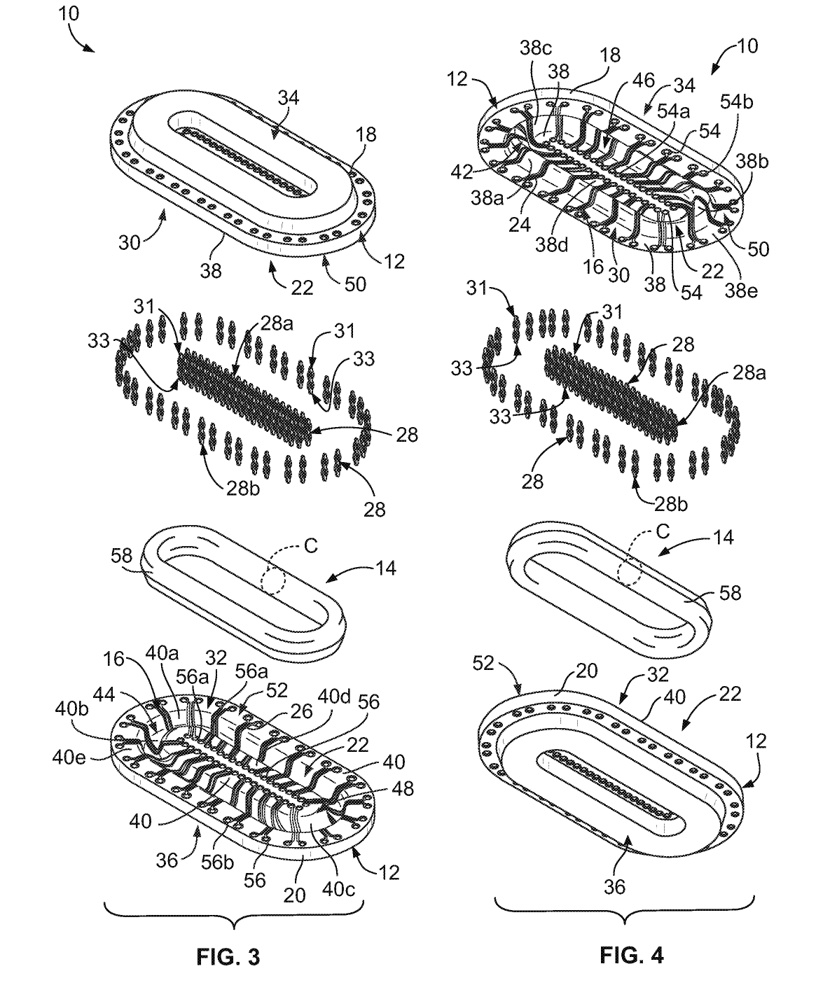

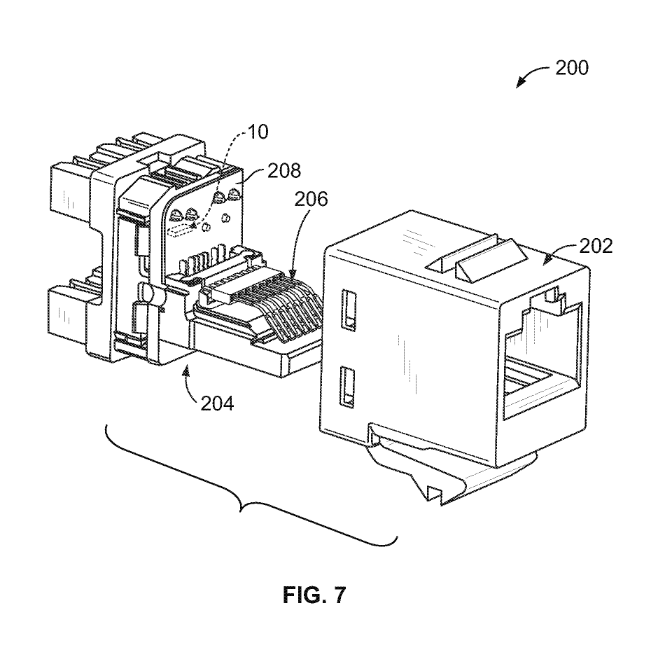

FIG. 1 is a perspective view of an exemplary embodiment of a magnetic device 10. FIG. 2 is a cross-sectional view of the magnetic device 10 taken along line 2-2 of FIG. 1. The magnetic device 10 generally includes a dielectric housing 12, a magnetic core 14 (not visible in FIG. 1) held by the housing 12, and an electrically conductive pattern 16 (not visible in FIG. 1) of wrappings around the magnetic core 14. The magnetic core 14 and the electrically conductive pattern 16 of wrappings are better shown in FIGS. 3 and 4. As will be described below, the electrically conductive pattern 16 of wrappings is configured to induce a magnetic field about the magnetic core 14. The magnetic device 10 may be configured to have any function, such as, but not limited to, a transformer, an inductor, a filter, a choke, a component of a relay, and/or the like. One specific example of a function of the magnetic device is a transformer that is integrated within an electrical connector (e.g., the electrical connector 200 shown in FIG. 7) for filtering data signals communicated through the electrical connector.

FIG. 3 is an exploded perspective view of the magnetic device 10. FIG. 4 is another exploded perspective view of the magnetic device 10 viewed from a different angle than FIG. 3. The housing 12 includes shells 18 and 20 that couple together to define an interior compartment 22 therebetween. The magnetic core 14 is disposed within the interior compartment 22. The electrically conductive pattern 16 of wrappings is defined by electrical traces 24 and 26 that are formed on the shells 18 and 20, respectively. The electrical traces 24 and 26 are electrically conductive. The electrical traces 24 on the shell 18 are electrically connected to corresponding electrical traces 26 on the shell 20 to form the pattern 16. In the exemplary embodiment, the corresponding electrical traces 24 and 26 are electrically connected via press-fit pins 28 of the magnetic device 10. The shells 18 and 20 may each be referred to herein as an “upper shell” and/or a “lower shell”. The electrical traces 24 and 26 may each be referred to herein as “upper electrical traces” and “lower electrical traces”.

The housing shells 18 and 20 include respective interior sides 30 and 32 and respective exterior sides 34 and 36. The interior sides 30 and 32 of the respective shells 18 and 20 include interior surfaces 38 and 40, respectively. When the shells 18 and 20 are coupled together, the interior sides 30 and 32 generally oppose, or face, each other. The interior sides 30 and 32 of the shells 18 and 20, respectively, include respective channels 42 and 44 that cooperate to define the interior compartment 22 when the shells 18 and 20 are coupled together. Segments 38a, 38b, 38c of the interior surface 38 of the shell 18 define the channel 42, while segments 40a, 40b, and 40c of the interior surface 40 of the shell 20 define the channel 44. The segments 38a, 38b, 38c, 40a, 40b, and 40c thereby define boundaries of the interior compartment 22. In some alternative embodiments, the interior compartment is defined by a channel that extends within only one of the shells 18 or 20. In other words, in some alternative embodiments, the shell 18 or the shell 20 does not include the respective channel 42 or 44.

In the exemplary embodiment, the channels 42 and 44 have toroidal shapes. The interior compartment 22 thereby has a toroidal shape in the exemplary embodiment. However, the channels 42 and 44 and the interior compartment 22 may have any other shape(s), which may depend on the shape of the magnetic core 14. Optionally, the shape of the interior compartment 22 is complementary with the shape of the magnetic core 14.

The interior sides 30 and 32 of the shells 18 and 20, respectively, include respective hubs 46 and 48. The hubs 46 and 48 extend centrally inside the toroidal shape of the respective channels 42 and 44. The segment 38c of the interior surface 38 of the shell 18 defines a side wall of the hub 46, while a segment 38d of the interior surface 38 defines a platform of the hub 46. Similarly, a sidewall of the hub 48 is defined by the segment 40c of the interior surface 40 of the shell 20. A platform of the hub 48 is defined by a segment 40d of the interior surface 40 of shell 20. In some alternative embodiments, the shell 18 or the shell 20 does not include the respective hub 46 or 48. The hubs 46 and 48 may each be referred to herein as an “upper hub” and a “lower hub”.

The shells 18 and 20 include flanges 50 and 52. More particularly, the interior side 30 of the shell 18 includes the flange 50, which is defined by a segment 38e of the interior surface 38 of the interior side 30. The flange 52 extends on the interior side 32 of the shell 20 and is defined by a segment 40e of the interior surface 40. The flanges 50 and 52 extend outside, or around, the toroidal shape of the respective channel 42 and 44.

Each of the shells 18 and 20 includes a plurality of electrical vias 54 and 56, respectively. The electrical vias 54 of the shell 18 include electrical vias 54a that extend within the platform 38d of the hub 46, and electrical vias 54b that extend within the flange 50. The electrical vias 56 of the shell 20 also include electrical vias 56a and 56b that extend within the platform 38d of the hub 48 and the flange 52, respectively. As will be described below, each electrical via 54 and 56 is electrically connected to a corresponding electrical trace 24 and 26, respectively, on the respective interior side 30 and 32.

The housing 12 may be fabricated from any dielectric material(s), such as, but not limited to, plastic, polymers, thermoplastic, polyimide, polyester, liquid crystal polymers, materials suitable for injection or another type of molding, and/or the like. The shells 18 and 20 of the housing 12 may each be fabricated using any suitable method, process, apparatus, structure, means, and/or the like. In some embodiments, the housing shells 18 and 20 are molded using any type of molding process. For example, in some embodiments, the shells 18 and 20 of the housing 12 are injection molded. The housing 12 is not limited to the shapes shown herein. Rather, the housing 12 may have any other exterior or interior shape than is shown herein.

The electrical traces 24 and 26 are formed on the interior sides 30 and 32, respectively, of the respective shells 18 and 20. More specifically, the electrical traces 24 are formed on the interior surface 38 of the interior side 30, and the electrical traces 26 are formed on the interior surface 40 of the interior side 32. The electrical traces 24 extend on the interior surface 38 of the shell 18 radially outwardly from the platform 38d of the hub 46 to the flange 50. The electrical traces 24 thereby extend from the segment 38e to the segment 38d, and on the segments 38a-c therebetween, of the interior surface 38 of the shell 18. Each electrical trace 24 is electrically connected to a corresponding electrical via 54a at the hub 46 and a corresponding electrical via 54b at the flange 50. The electrical traces 24 thereby define electrical paths on the interior surface 38 that extend from the electrical vias 54a on the hub 46 to the electrical vias 54b on the flange 50.

The electrical traces 26 extend on the interior surface 40 of the shell 20 radially outwardly from the platform 40d of the hub 48 to the flange 52. The electrical traces 26 extend on the segments 40a-40e of the interior surface 40 of the shell 20. Each electrical trace 26 is electrically connected to a corresponding electrical via 56a at the hub 48 and a corresponding electrical via 56b at the flange 52. The electrical traces 26 define electrical paths on the interior surface 40 that extend from the electrical vias 56a on the hub 48 to the electrical vias 56b on the flange 52.

The electrical traces 24 and 26 may be formed on the respective shells 18 and 20 using any suitable method, process, apparatus, structure, means, and/or the like. Examples of forming the electrical traces 24 and 26 on the shells 18 and 20 include, but are not limited to, plating, using lithography, stamping, using a laser, and/or the like. Plating may include, but is not limited to, chemical plating, electroplating, electroless plating, adhesive metal plating, plated plastic technology, and/or the like. In the exemplary embodiment, the electrical traces 24 and 26 are formed on the respective shells 18 and 20 using a type of plated plastic technology called “dual shot”. Dual shot plated plastic technology includes fabricating each of the shells 18 and 20 from two different dielectric materials, one of which is plateable and the other of which is not plateable. The locations on the shells 18 and 20 that the respective electrical traces 24 and 26 extend on are fabricated from the dielectric material that is plateable, while locations on the shells 18 and 20 that do not include the respective electrical traces 24 and 26 are fabricated from the dielectric material that is not plateable. Each electrical trace 24 and 26 may be fabricated from any electrically conductive material(s), such as, but not limited to, copper, tin, aluminum, gold, and/or the like.

The magnetic core 14 is disposed within the interior compartment 22 of the housing 12 and includes a body 58. In the exemplary embodiment, the body 58 of the magnetic core 14 has the shape of a toroid. In other words, the exemplary embodiment of the body 58 of the magnetic core 14 extends along a toroidal path. The body 58 includes a circumference C that extends along the toroidal path of the body 58. The body 58 of the magnetic core 14 may have any other shape besides the toroidal shape shown and described herein. Other shapes of the body 58 include, but are not limited to, a rod shape, an oblong shape, and/or the like. Optionally, the shape of the magnetic core body 58 is complementary with the shape of the interior compartment 22.

The body 58 of the magnetic core 14 may be fabricated from any material(s), for example ferromagnetic materials that may include, but are not limited to, ferrites, iron, metals, metal alloys, and/or the like. The material(s) of the magnetic core body 58 may be selected based on the desired functionality of the magnetic device 10.

As described above, in the exemplary embodiment, corresponding electrical traces 24 and 26 are electrically connected together via the press-fit pins 28. Each press-fit pin 28 is electrically conductive and includes opposite ends 31 and 33 that are configured to be press-fit within corresponding electrical vias 54 and 56, respectively, of the shells 18 and 20, respectively. The ends 31 and 33 are electrically connected to the respective electrical vias 54 and 56 when received therein. The press-fit pins 28 thereby define electrical paths from the electrical vias 54 to the electrical vias 56. The press-fit pins 28 include pins 28a that are received within corresponding electrical vias 54a and 56a of the hubs 46 and 48, respectively, and pins 28b that are received within corresponding electrical vias 54b and 56b of the flanges 50 and 52, respectively.

In the exemplary embodiment, the ends 31 and 33 of the press-fit pins 28 include an eye-of-the needle geometry that deforms when the end 31 and 33 is received the corresponding electrical via 54 and 56, respectively. But, each of the ends 31 and 33 may alternatively have a different type of structure that is configured to be press-fit within the corresponding electrical via 54 and 56, respectively.

Referring again to FIG. 2, when the magnetic device 10 is assembled, the interior sides 30 and 32 of the shells 18 and 20, respectively, oppose each other and define the interior compartment 22 therebetween. The magnetic core 14 is disposed within the interior compartment 22. Specifically, the magnetic core 14 is held within the channels 42 and 44 of the shells 18 and 20, respectively. As can be seen in FIG. 2, the electrical traces 24 are disposed between the shell 18 and the body 58 of the magnetic core 14, and the electrical traces 26 are disposed between the shell 20 and the magnetic core body 58.

The ends 31 and 33 of the press-fit pins 28 are received within, and electrically connected to, the corresponding electrical vias 54 and 56, respectively, of the shells 18 and 20, respectively. More specifically, the press-fit pins 28a are received within, and electrically connected to, corresponding electrical vias 54a and 56a of the hubs 46 and 48, respectively, of the respective shells 18 and 20. The press-fit pins 28a thereby electrically connect corresponding electrical traces 24 and 26 of the shells 18 and 20, respectively, to each other at the respective hubs 46 and 48. The press-fit pins 28b are received within, and electrically connected to, corresponding electrical vias 54b and 56b of the flanges 50 and 52, respectively, of the shells 18 and 20, respectively. Accordingly, the press-fit pins 28b electrically interconnect corresponding electrical traces 24 and 26 of the shells 18 and 20, respectively, at the flanges 50 and 52, respectively.

Each combination of corresponding electrical traces 24 and 26 and the press-fit pins 28a and 28b that interconnect the corresponding traces 24 and 26 defines an electrical path that extends, or wraps, completely around the circumference C of the magnetic core body 58. As should be evident from FIGS. 3 and 4, the electrical traces 24 and 26 and the press-fit pins 28 thereby define the electrically conductive pattern 16 of wrappings that extend around the circumference C of the magnetic core body 58 along the toroidal path of the body 58. When electrically connected to a source of electrical current, the electrically conductive pattern 16 of wrappings is configured to induce a magnetic field about the magnetic core 14. The arrangement of the pattern 16 (such as, but not limited to, the number, size, and/or spacing between the wrappings; whether or not adjacent wrappings are electrically connected together and/or continuous; and/or the like) may be selected to provide the magnetic device 10 with the desired functionality.

In the exemplary embodiment, the press-fit pins 28 mechanically hold the shells 18 and 20 together. More specifically, the engagement between the ends 31 and 33 of the press-fit pins 28 and the electrical vias 54 and 56, respectively, provides sufficient stiction to hold the shells 18 and 20 together. But, the magnetic device 10 may include any other structure for mechanically holding the shells 18 and 20 together in addition or alternative to the press-fit pins 28.

The electrical connection between corresponding electrical traces 24 and 26 of the shells 18 and 20, respectively, is not limited to the press-fit pins 28. Rather, other structures, materials, means, and/or the like may be used to electrically connect corresponding electrical traces 24 and 26 together. For example, in some embodiments non-press-fit pins (not shown; e.g., solder tails and/or the like) are used to electrically connect corresponding electrical traces 24 and 26 together. Moreover, and for example, an electrically conductive epoxy, solder, and/or the like may be used to electrically connect corresponding electrical traces 24 and 26 of the shells 18 and 20, respectively, together.

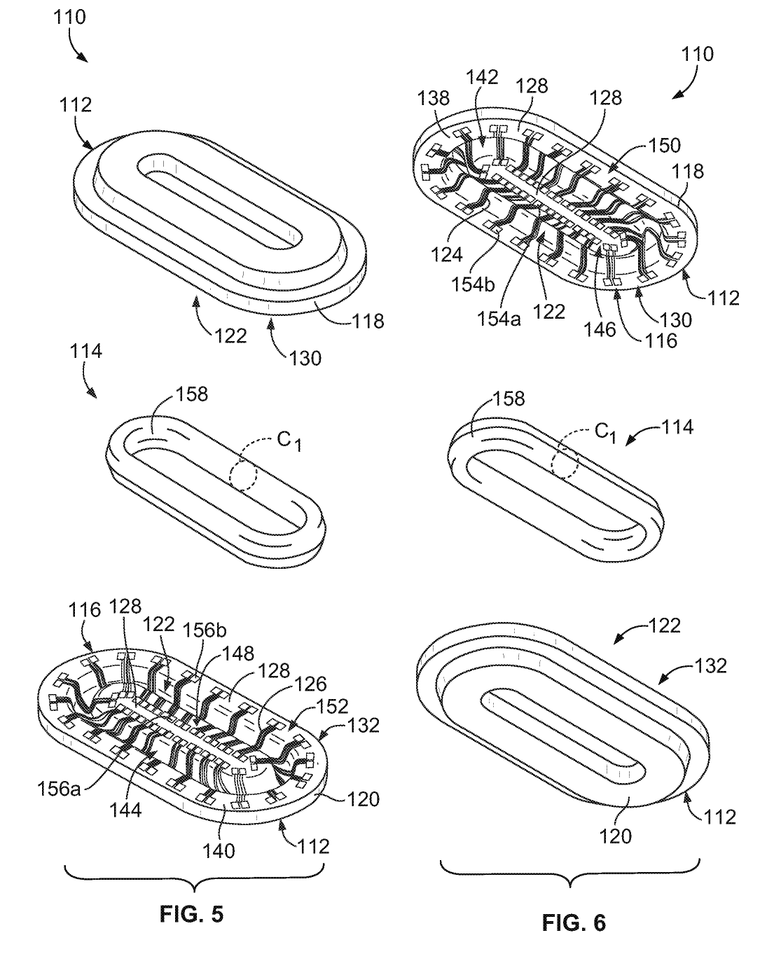

FIG. 5 is an exploded perspective view of another exemplary embodiment of a magnetic device 110. FIG. 6 is another exploded perspective view of the magnetic device 110 viewed from a different angle than FIG. 5. The magnetic device 110 generally includes a dielectric housing 112, a magnetic core 114 held by the housing 112, and an electrically conductive pattern 116 of wrappings around the magnetic core 114. The housing 112 includes shells 118 and 120 that couple together to define an interior compartment 122 therebetween. The electrically conductive pattern 116 of wrappings is defined by electrical traces 124 and 126 that are formed on the shells 118 and 120, respectively. The electrical traces 124 on the shell 118 are electrically connected to corresponding electrical traces 126 on the shell 120 via an electrically conductive epoxy 128, as will be described in more detail below. The shells 118 and 120 may each be referred to herein as an “upper shell” and/or a “lower shell”. The electrical traces 124 and 126 may each be referred to herein as “upper electrical traces” and “lower electrical traces”.

The housing shells 118 and 120 include respective interior sides 130 and 132 having respective interior surfaces 138 and 140. The interior sides 130 and 132 of the shells 118 and 120, respectively, include respective channels 142 and 144 that cooperate to define the interior compartment 122. The interior sides 130 and 132 of the shells 118 and 120, respectively, include respective hubs 146 and 148 and respective flanges 150 and 152. The hubs 146 and 148 may each be referred to herein as an “upper hub” and a “lower hub”.

The electrical traces 124 and 126 are formed on the interior surfaces 138 and 140, respectively, of the interior sides 130 and 132, respectively, of the respective shells 118 and 120. The electrical traces 124 extend on the interior surface 138 radially outwardly from the hub 146 to the flange 150. Each electrical trace 124 includes an end 154a that extends on the hub 146 and an opposite end 154b that extends on the flange 150. Similarly, the electrical traces 126 extend on the interior surface 140 radially outwardly from the hub 148 to the flange 152. Each electrical trace 126 includes an end 156a that extends on the hub 148 and an opposite end 156b that extends on the flange 152.

When the magnetic device 110 is assembled, the interior sides 130 and 132 of the shells 118 and 120, respectively, oppose each other and define the interior compartment 122 therebetween. The magnetic core 114 is disposed within the interior compartment 122. The electrical traces 124 are disposed between the shell 118 and a body 158 of the magnetic core 114. The electrical traces 126 are disposed between the shell 120 and the magnetic core body 158.

The electrically conductive epoxy 128 is bonded with the interior sides 130 and 132 of the shells 118 and 120, respectively, to mechanically hold the shells 118 and 120 together. More specifically, the electrically conductive epoxy 128 is bonded to the interior surfaces 138 and 140 of the interior sides 130 and 132, respectively, at the respective hubs 146 and 148 and at the respective flanges 150 and 152. The electrically conductive epoxy 128 is bonded to, and extends between, corresponding ends 154a and 156a of corresponding electrical traces 124 and 126, respectively. The electrically conductive epoxy 128 thereby electrically connects corresponding electrical traces 124 and 126 of the shells 118 and 120, respectively, to each other at the respective hubs 146 and 148. The electrically conductive epoxy 128 is also bonded to, and extends between, corresponding ends 154b and 156b of corresponding electrical traces 124 and 126, respectively. Accordingly, the electrically conductive epoxy 128 electrically connects corresponding electrical traces 124 and 126 to each other at the respective flanges 150 and 152.

Each combination of corresponding electrical traces 124 and 126 and the electrically conductive epoxy 128 that interconnect the corresponding traces 124 and 126 defines an electrical path that extends, or wraps, completely around a circumference C₁ of the magnetic core body 158. The electrical traces 124 and 126 and the electrically conductive epoxy 128 thereby define the electrically conductive pattern 116 of wrappings that extend around the circumference C₁ of the magnetic core body 158. When electrically connected to a source of electrical current, the electrically conductive pattern 116 of wrappings is configured to induce a magnetic field about the magnetic core 114.

In some alternative embodiments, the electrically conducive epoxy 128 is not bonded to the interior surfaces 138 and 140 of the shells 118 and 120, respectively. Rather, is such alternative embodiments, the electrically conductive epoxy 128 is only bonded to the ends 154 and 156 of the electrical traces 124 and 126, respectively. The bond between the electrically conductive epoxy 128 and the ends 154 and 156 may mechanically hold the shells 118 and 120 together in such alternative embodiments. However, the magnetic device 110 may additionally or alternatively include any other structure for mechanically holding the shells 118 and 120 together in such alternative embodiments.

The electrically conductive epoxy 128 may be any type of electrically conductive epoxy, such as, but not limited to, silver conductive epoxy and/or the like. One example of a suitable electrically conductive epoxy is Electrodag™ 5810 Conductive Epoxy, commercially available from Thorlabs of Newton, New Jersey. In some embodiments, solder is used as an alternative to the electrically conducive epoxy 128.

FIG. 7 is a partially exploded perspective view of a portion of an exemplary embodiment of an electrical connector 200 that includes the magnetic device 10. The electrical connector 200 includes a housing 202 and a contact sub-assembly 204 held by the housing 202. The contact sub-assembly 204 includes an array of electrical contacts 206 that are configured to mate with corresponding electrical contacts (not shown) of a mating connector (not shown). The electrical contacts 206 are terminated to a printed circuit board (PCB) 208, which is electrically connected to the wires (not shown) of a cable (not shown) that the electrical connector 200 terminates. In the exemplary embodiment, the magnetic device 10 is embedded within the PCB 208 and is electrically connected to at least one of the electrical contacts 206 for filtering data signals communicated through the electrical contact(s) 206. The housing 202 of the electrical connector 200 may be referred to herein as a “connector housing”.

In the exemplary embodiment, the electrical connector 200 is an RJ-45 jack. However, the magnetic devices described and/or illustrated herein are not limited to RJ-45 jacks, but rather may be used with any other type of electrical connector.

The embodiments described and/or illustrated herein may provide a magnetic device that suffers from less part-to-part performance variation than at least some known magnetic devices. For example, the embodiments described and/or illustrated herein may provide a magnetic device having an electrically conductive pattern of wrappings that can be more reliably, more accurately, and/or more repeatabley positioned around a magnetic core of the device than at least some known magnetic devices. Moreover, the embodiments described and/or illustrated herein may provide a magnetic device that is less time-consuming to manufacture, and therefore less costly, than at least some known magnetic devices. For example, the embodiments described and/or illustrated herein may eliminate the need to manually wind one or more wires around a magnetic core, which may reduce manufacturing costs by reducing the amount and/or skill of labor required to fabricate the magnetic device.

It is to be understood that the above description and the figures are intended to be illustrative, and not restrictive. For example, the above-described and/or illustrated embodiments (and/or aspects thereof) may be used in combination with each other. In addition, many modifications may be made to adapt a particular situation or material to the teachings of the subject matter described and/or illustrated herein without departing from its scope. Dimensions, types of materials, orientations of the various components (including the terms “upper”, “lower”, “vertical”, and “lateral”), and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description and the figures. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A magnetic device comprising:
a molded dielectric housing comprising an upper shell and a lower shell that are coupled together to define an interior compartment therebetween, the upper and lower shells comprising interior sides that generally oppose each other and include interior surfaces;
a magnetic core disposed within the interior compartment of the housing;
upper electrical traces formed on the interior surface of the upper shell; and
lower electrical traces formed on the interior surface of the lower shell, wherein corresponding upper and lower electrical traces are electrically connected together to form an electrically conductive pattern of wrappings around the magnetic core that is configured to induce a magnetic field about the magnetic core.

2. The magnetic device of claim 1, further comprising press-fit pins, the upper and lower shells comprising electrical vias that are electrically connected to corresponding upper and lower electrical traces, respectively, wherein each press-fit pin is received within corresponding electrical vias of the upper and lower shells to electrically connect corresponding upper and lower electrical traces together.

3. The magnetic device of claim 1, further comprising an electrically conductive epoxy bonded with the upper and lower shells to hold the upper and lower shells together, wherein the electrically conductive epoxy is bonded and electrically connected to the upper and lower electrical traces such that the electrically conductive epoxy electrically connects corresponding upper and lower electrical traces together.

4. The magnetic device of claim 1, wherein the upper and lower shells comprise respective upper and lower hubs, the upper and lower electrical traces extending on the interior surfaces radially outwardly from the upper and lower hubs, respectively.

5. The magnetic device of claim 1, wherein the upper and lower electrical traces are plated plastic electrical traces.

6. The magnetic device of claim 1, further comprising press-fit pins, the upper and lower shells comprising electrical vias that are electrically connected to corresponding upper and lower electrical traces, respectively, each press-fit pin being received within corresponding electrical vias of the upper and lower shells to electrically connect corresponding upper and lower electrical traces together, wherein the press-fit pins hold the upper and lower shells together.

7. The magnetic device of claim 1, wherein the interior compartment of the housing comprises a toroidal shape defined by at least one of a toroidally shaped channel extending within the interior side of the upper shell or a toroidally shaped channel extending within the interior side of the lower shell.

8. The magnetic device of claim 1, wherein the magnetic core comprises a toroidal shape.

9. The magnetic device of claim 1, wherein the upper electrical traces are disposed between the magnetic core and the upper shell, and the lower electrical traces are disposed between the magnetic core and the lower shell.

10. The magnetic device of claim 1, wherein the upper and lower shells are injection molded.

11. The magnetic device of claim 1, wherein the magnetic core comprises a ferromagnetic material.

12. A magnetic device comprising:
a dielectric housing comprising an upper shell and a lower shell that are coupled together to define an interior compartment therebetween, the upper and lower shells comprising interior sides;
a magnetic core disposed within the interior compartment of the housing;
upper electrical traces formed on the upper shell;
lower electrical traces formed on the lower shell; and
an electrically conductive epoxy bonded with the interior sides of the upper and lower shells to hold the upper and lower shells together, the electrically conductive epoxy being bonded and electrically connected to the upper and lower electrical traces such that the electrically conductive epoxy electrically connects corresponding upper and lower electrical traces together, wherein corresponding upper and lower electrical traces form an electrically conductive pattern of wrappings around the magnetic core that is configured to induce a magnetic field about the magnetic core.

13. The magnetic device of claim 12, wherein the upper and lower electrical traces are formed on interior surfaces of the interior sides of the upper and lower shells, respectively.

14. The magnetic device of claim 12, wherein the upper and lower shells of the housing are molded.

15. The magnetic device of claim 12, wherein the upper and lower shells comprise respective upper and lower hubs, the upper and lower electrical traces extending on the interior surfaces radially outwardly from the upper and lower hubs, respectively.

16. The magnetic device of claim 12, wherein the upper and lower electrical traces are plated plastic electrical traces.

17. The magnetic device of claim 12, wherein the interior compartment of the housing comprises a toroidal shape defined by at least one of a toroidally shaped channel extending within the interior side of the upper shell or a toroidally shaped channel extending within the interior side of the lower shell.

18. The magnetic device of claim 12, wherein the magnetic core comprises a toroidal shape.

19. The magnetic device of claim 12, wherein the magnetic core comprises a ferromagnetic material.

20. An electrical connector comprising:
a connector housing;
an electrical contact held by the connector housing; and
a magnetic device electrically connected to the electrical contact of the housing, the magnetic device comprising:
a molded dielectric housing comprising an upper shell and a lower shell that are coupled together to define an interior compartment therebetween, the upper and lower shells comprising interior sides that generally oppose each other and include interior surfaces;
a magnetic core disposed within the interior compartment of the housing;
upper electrical traces formed on the interior surface of the upper shell; and
lower electrical traces formed on the interior surface of the lower shell, wherein corresponding upper and lower electrical traces are electrically connected together to form an electrically conductive pattern of wrappings around the magnetic core that is configured to induce a magnetic field about the magnetic core.
